(19) United States
(12) Patent Application Publication
(10) Pub. No.: US 2010/0316935 A1
(43) Pub. Date: Dec. 16, 2010

(54) ELECTROCHEMICAL CELLS CONNECTED IN FLUID FLOW SERIES

(75) Inventors: Cody A. Friesen, Mesa, AZ (US); Joel R. Hayes, Chandler, AZ (US); Ramkumar Krishnan, Gilbert, AZ (US); Todd Trimble, Scottsdale, AZ (US)

Correspondence Address: PILLSBURY WINTHROP SHAW PITTMAN, LLP, P.O. BOX 10500, MCLEAN, VA, 22102, US

(73) Assignee: Fluidic, LLC, Scottsdale, AZ (US)

(21) Appl. No.: 12/631,484

(22) Filed: Dec. 4, 2009

Related U.S. Application Data
(60) Provisional application No. 61/193,540, filed on Dec. 5, 2008.

(51) Int. Cl. H01M 8/02

(52) U.S. Cl. 429/512

(57) ABSTRACT

An electrochemical cell system for generating electrical power is disclosed. The electrochemical cell system comprises a plurality of fluidly connected electrochemical cells. Each electrochemical cell comprises an anode and a cathode. The anode is configured to permit a fluid comprising at least an electrolyte to flow in contact therewith to oxidize a fuel. The cathode is permeable to an oxidizer and is configured to receive electrons to reduce the oxidizer. The cathode and the anode are spaced apart to define a gap therebetween for receiving the fluid flow. The plurality of electrochemical cells are connected in fluid flow series such that, for each pair of fluidly connected electrochemical cells, the fluid flows from a first cell of the pair of cells to a second cell of the pair of cells. The plurality of electrochemical cells are connected electrically in series such that, for each pair of fluidly connected electrochemical cells, the cathode of the first cell of the pair is electrically connected to the anode of the second cell of the pair.

### PRIORITY INFORMATION

This application claims priority to U.S. Provisional Application Ser. No. 61/193,540, filed Dec. 5, 2008, the entirety of which is incorporated herein.

### FIELD

The present application relates to an electrochemical cell system for generating power, and more particularly to a plurality of electrochemical cells connected in fluid flow series.

### BACKGROUND

Electrochemical cells are increasingly used as energy conversion devices to convert chemical energy into electrical energy that can be used in various applications including supplying power to electrical powered devices, to transportation vehicles and other applications.

Electrochemical cells with a liquid electrolyte are known. Increasing the overall outputting system based on a liquid electrolyte cell architecture presents particular challenges. The present application endeavors to provide a viable and effective system based on a liquid electrolyte cell architecture that delivers outputs at a high potential.

### SUMMARY

According to an aspect of the present invention, there is provided an electrochemical cell system for generating electrical power is disclosed. The electrochemical cell system comprises a plurality of fluidly connected electrochemical cells. Each electrochemical cell comprises an anode and a cathode. The anode is configured to permit a fluid comprising at least an electrolyte to flow in contact therewith to oxidize a fuel. The cathode is permeable to an oxidizer and is configured to receive electrons to reduce the oxidizer. The cathode and the anode are spaced apart to define a gap therebetween for receiving the fluid flow. The plurality of electrochemical cells are connected in fluid flow series such that, for each pair of fluidly connected electrochemical cells, the fluid flows from a first cell of the pair of cells to a second cell of the pair of cells. The plurality of electrochemical cells are connected electrically in series such that, for each pair of fluidly connected electrochemical cells, the cathode of the first cell of the pair is electrically connected to the anode of the second cell of the pair. An ionic resistance between the pair of fluidly connected electrochemical cells is greater than an ionic resistance within one electrochemical cell in the pair of cells.

According to another aspect of the present invention, there is provided an electrochemical cell system for generating electrical power. The electrochemical cell system includes a plurality of fluidly connected electrochemical cells. Each electrochemical cell comprises an anode configured to permit a fluid comprising at least an electrolyte to flow in contact therewith to oxidize a fuel, and a cathode permeable to an oxidizer, the cathode being configured to receive electrons to reduce the oxidizer. The cathode and the anode are spaced apart to define a gap therebetween for receiving the fluid flow. The plurality of electrochemical cells are connected in fluid flow series via a plurality of passageways such that, for each pair of fluidly connected electrochemical cells, the fluid flows from a first cell of the pair of cells to a second cell of the pair of cells through one passageway in the plurality of passageways. A length of the one passageway is greater than a minimum distance of the gap between the anode and the cathode. The plurality of electrochemical cells are connected electrically in series such that, for each pair of fluidly connected electrochemical cells, the cathode of the first cell of the pair is electrically connected to the anode of the second cell of the pair.

According to yet another aspect of the present invention, there is provided a method for generating electrical current using an electrochemical cell system comprising a plurality of electrochemical cells. The method includes flowing a fluid comprising an electrolyte through the plurality of cells, each electrochemical cell in the plurality of cells comprising an anode and a cathode spaced apart by a gap, the gap being provided along the fluid flow path, and inputting an oxidizer through the cathode of each electrochemical cell in the plurality of cells, the cathode being permeable to the oxidizer. In each electrochemical cell in the plurality of cells, fuel is oxidized at the anode and the oxidizer is reduced at the cathode, and a by-product is formed by reaction of the oxidized fuel and reduced oxidizer in the electrolyte.

Other objects, features, and advantages of the present invention will become apparent from the following detailed description, the accompanying drawings, and the appended claims.

### BRIEF DESCRIPTION OF THE DRAWINGS

FIG. 1 is a schematic view of a fuel cell showing a flow path of the electrolyte, according to an embodiment of the present invention;

FIG. 2 is a schematic view of an electrochemical fuel cell system comprising two fuel cells connected in fluid flow series, according to an embodiment of the present invention;

FIG. 3 shows the fuel cells depicted in FIG. 2 connected in parallel, according to another embodiment of the invention;

FIGS. 4 and 5 are an exploded, perspective views of an electrochemical cell system that includes four electrochemical fuel cells, according to an embodiment of the present invention;

FIG. 6 depicts the electrochemical cell system shown in FIGS. 4 and 5 where the anode holder holding the anodes and the cathode holder holding the cathodes are positioned inside a housing, according to an embodiment of the present invention;

FIG. 7 is a top view of the electrochemical cell system 40 depicted in FIG. 6 showing the relative position of the cathode holder, cathodes, and anode holder;

FIG. 8 is a schematic view of the electrochemical fuel cell system with two fuel cells connected in fluid flow series, according to an embodiment of the present invention;

FIG. 9 is an exploded, perspective view of an electrochemical fuel cell system, according to another embodiment of the present invention; and

FIG. 10 is an elevation view of the electrochemical cell system depicted in FIG. 9.

### DETAILED DESCRIPTION

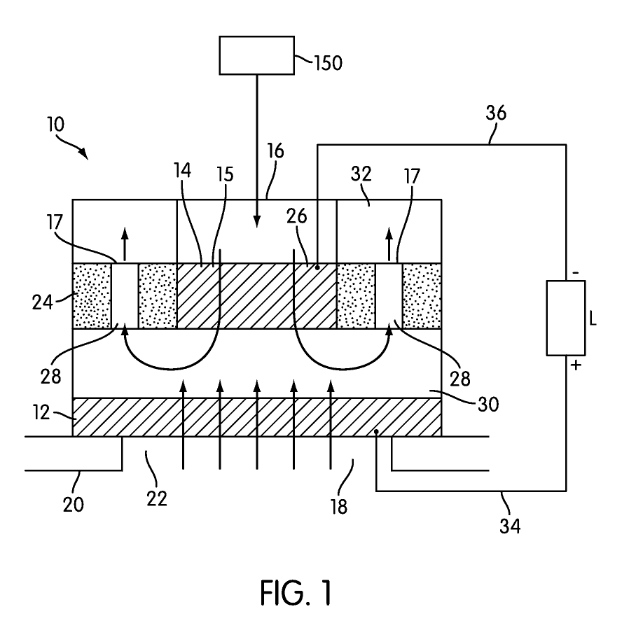

FIG. 1 is a schematic view of an electrochemical cell, according to an embodiment of the present invention. A detailed description of an electrochemical cell is provided in provisional patent application entitled “Electrochemical Cell, and Particularly a Metal Fuel Cell With Non-Parallel Flow,” Cody A. Friesen et al., filed on Apr. 4, 2008, Ser. No. 61/064,955, and its related utility application Ser. No. 12/385,217, filed on Apr. 1, 2009, the entire contents of each which is incorporated herein by reference. The electrochemical fuel cell 10 includes a cathode 12 and an anode 14. As used herein, the anode 14 is where the fuel of the system is oxidized; as discussed in further detail below. The electrochemical fuel cell 10 further includes a fuel and electrolyte inlet(s) 16 for inputting fuel, electrolyte or a combination thereof and outlet(s) 17 for outputting non-consumed fuel, electrolyte and by-products of the electrochemical reaction carried out in the electrochemical cell 10, as will be explained further in detail in the following paragraphs. The inlet 16 can be, for example, connected to a fuel source and an electrolyte source (not shown) or connected to a combination fuel-electrolyte source (not shown). The fuel cell 10 further includes an oxidizer input 18, which allows an oxidizer to enter the fuel cell 10.

The fuel cell 10 includes a base 20 that is configured to support the cathode 12 and other components of fuel cell 10. The base 20 has an opening 22 through which the oxidizer is introduced into the fuel cell 10. The oxidizer input 18 can communicate with the cathode 12 through the opening 22. The anode 14 is supported by an anode holder 24 which in turn is supported by the base 20. In one embodiment, the anode 14 is disposed in a receiving cavity 15 provided in the anode holder 24.

The anode holder 24 is provided with one or more return channels 28 that circumferentially surround and extend through the anode holder 24. The return channels 28 are terminated on one side by outlet(s) 17. In one embodiment, the return channels 28 have a cross-sectional area that is substantially smaller than the cross-sectional area of the anode receiving cavity 15. The return channels 28 can be sized to provide a positive return flow of the electrolyte carrying the by-product of the electrochemical reaction taking place in the electrochemical cell 10 to the electrolyte and by-product outlet 17.

The cathode 12 and the anode 14 are held substantially parallel to each other and are spaced apart from each other to define a gap 30. The gap 30 can be an essentially empty gap such that fluid flows from the anode 14 to the cathode 12 and then back out the return channels 28 (discussed below). In one embodiment, the gap 30 can be constant across a surface of the cathode 12 or anode 14. However, in some configurations the gap may vary across the surface of the cathode 12 or anode 14.

In an embodiment, the gap 30 between the cathode 12 and anode 14 may have channels or other features for facilitating flow of electrolyte and oxidized fuel. However, a proton exchange membrane is not provided in the gap 30. Instead, fluid flow of the electrolyte and oxidized fuel is allowed to flow relatively “freely” through the gap 30, as explained in the following paragraphs. The gap 30 can be occupied or unoccupied. For example, the gap 30 can be occupied by a porous, non-reactive, and non-conductive spacer that still allows flow of fluid. For example, a spacer having a honeycomb configuration, a material grid, a porous material or a porous frit can be used. In another embodiment, the gap 30 is unoccupied and can be provided as an open space that allows for convective flow.

Each return channel 28 communicates the gap 30 to a return space 32 that is defined by the anode holder 24 and a gasket (not shown) that seals a top side of the anode holder 24. The return space 32 communicates with the outlet(s) 17. The return space 32 is separated from the receiving space 15 of the anode 14 by walls provided in the anode holder 24. The anode holder 26 can be made from a non-conductive, lightweight material, such as plastic, although any suitable material can be used.

Other suitable constructions and configurations for the holder 26, the channels 28 and the return space 32 may also be used and the illustrated embodiment is not regarded as limiting.

In one embodiment, the cathode 12 comprises a porous body covered on the outer side, i.e., the side facing the input 18, by a gas permeable layer through which an oxidizer may diffuse, but the electrolyte may not pass through. That is, the layer is gas permeable, but not permeable by the electrolyte (i.e., it is gas permeable but not liquid permeable). Alternatively or in addition, the porous body may be covered on the inner side (the side facing the anode 14) by a liquid permeable layer through which the electrolyte may pass through so that the electrolyte may contact the porous body. The porous body of the cathode 12 has a high surface area and comprises a catalyst material that has a high activity for an oxidizer reduction reaction. The cathode 12 is shown schematically in FIG. 1 as having a substantially planar configuration. However, cathode 12 can have various other configurations. For example, the cathode 12 can have a “sawtooth” configuration or “a corrugated” configuration or the like. In this case, the surface area of the cathode 12 in contact with the electrolyte can be increased while the dimensions (e.g., length) of the cathode 12 can be tailored to fit in the space provided to hold the cathode 12.

In one embodiment, the cathode can be a passive or “breathing” cathode that is passively exposed, such as through the opening 22, to the oxidizer source (for example oxygen present in ambient air) and absorbs the oxidizer for consumption in the electrochemical cell reactions. Specifically, the oxidizer (e.g., oxygen) will permeate from the ambient air into the cathode 12. Thus, the oxidizer need not be actively pumped or otherwise directed to the cathode. In another embodiment forced air (containing oxygen) can also be used as the oxidizer source. In which case a pump may be provided to pump air through the opening 22. Any part of the cathode 12 by which the oxidizer is absorbed or otherwise permeates or contacts the cathode 12 may be generically referred to as an “input.” The term input may broadly encompass all ways of delivering oxidizer to the cathode (and that term may similarly be used with reference to any way of delivering fuel to the anode). In the illustrated embodiments, the opening 22 in the lower base 20 define the input 18 for oxidizer, because the openings allow the oxidizer to come into contact with the cathode 12.

The cathode 12 includes a catalyst material, such as manganese oxide, nickel, cobalt, activated carbon, platinum, silver, or any other catalyst material or mixture of materials with high oxygen reduction activity in the electrolyte for catalyzing reduction of the oxidizer, which will be discussed below. The porous body of the cathode 12 may comprise the catalyst material.

In one embodiment, the anode 14 can include a filter material 26 configured to capture solid fuel particles. However, the anode can be made of any other material. In one embodiment, the filter 26 can be retained in the anode holder 24. The filter material 26 can be configured to allow the electrolyte to flow through it. In one embodiment, the combination of the filter material 26 and the captured fuel particles form the anode 14. In an embodiment, the filter material 26 can include a carbon filter that is made from carbon fiber, a tightly woven mesh of brass, bronze, stainless steel, nickel, monel, any other conductive filter material, or any combination of these materials. Other materials or methods of forming the filter body 26 of anode 14 may also be used. For example, the filter material 26 may include channels, grooves, bores, pores, mesh, or any other formations able to capture and retain the fuel particles.

In one embodiment, the inlet 16 for introducing the electrolyte is aligned directly with the anode 14 and its filter body 26. A flow generator or pumping system 15 can be provided to pump the fluid containing the electrolyte into the electrochemical fuel cell 10. The fuel particles can be provided to the electrochemical cell 10 into the filter through another route. In other cell embodiments, such as battery embodiments, the fuel can be pre-loaded on to the anode or deposited by electrodeposition.

Oxidation of the fuel at the anode 14 provides oxidized fuel ions that may exit the filter material 26 and enter the gap 30, along with the electrolyte. By retaining the fuel particles in the filter material 26, a constant source of released or liberated electrons and resulting fuel ions may be provided. As the fuel particles become depleted, additional fuel particles may be provided to the electrochemical cell 10 be captured by the filter body 26.

Within the gap 30, a transport flow of the electrolyte flows across the gap 30 from the filter material 26 of the anode 14 to the cathode 12. The term “transport flow” refers to a fluid flow of the electrolyte across the gap, which transports the oxidized fuel ions away from the anode 14 and towards the cathode 12. Thus, in this non-limiting embodiment, the ions are transported convectively by the flowing electrolyte, rather than relying solely on diffusion within the electrolyte. In contrast, in electrochemical cells with proton exchange membranes, the membrane itself is an electrolyte that transports the oxidized fuel ions by conduction. Here, the primary direction of the transport flow is away from the anode 14 to the cathode 12 and then radially outward and back into the return channels 28.

Electrical leads 34, 36 are provided to electrically connect the cathode 12 and the anode 14 to a load L. During operation, when the anode 14 and the cathode 12 are coupled to the load L, reaction among at least the oxidizer and the electrons flowing to the cathode 12 through the load L will occur at the cathode, thus reducing the oxidizer. The reduced oxidizer ions may react with the oxidized fuel ions to complete the electrochemical cell reaction.

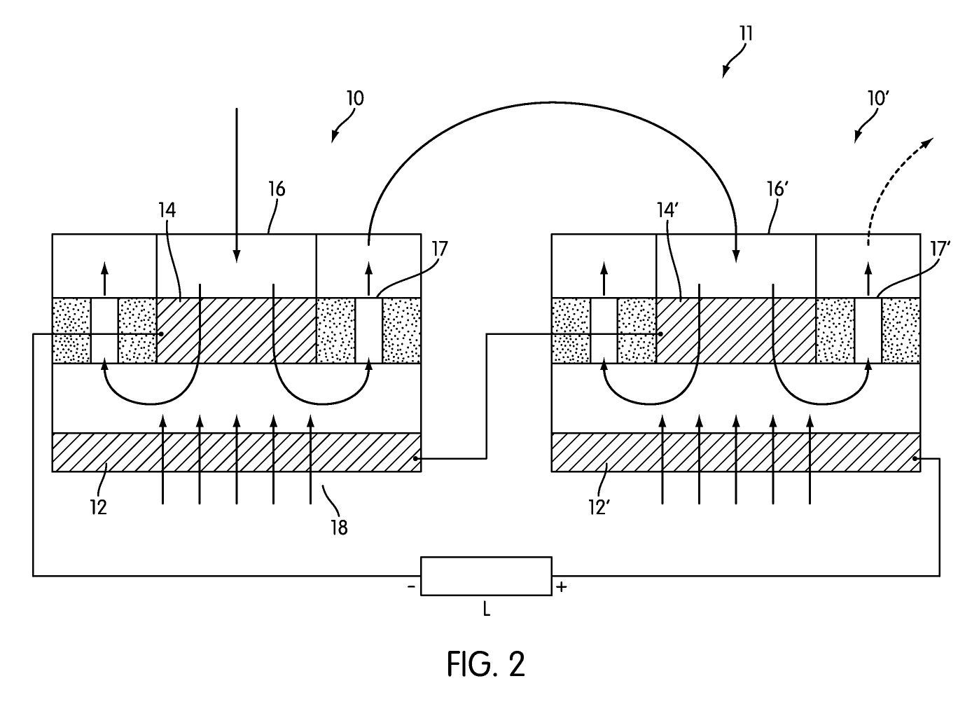

FIG. 2 is a schematic view of an electrochemical fuel cell system comprising two fuel cells connected in fluid flow series in which a fluid containing the electrolyte with or without the fuel flows in series over the two fuel cells, according to an embodiment of the present invention. The electrochemical fuel cell system 11 comprises two fuel cells, a first fuel cell 10 and a second fuel cell 10′. The second fuel cell 10′ can be the same as the first fuel cell 10 or a different fuel cell. The fluid containing the electrolyte is input through first inlet 16 of the first fuel cell 10. An electrochemical reaction occurs in the first fuel cell 10 where at least a portion of the fluid containing the electrolyte and the fuel react to produce a flow of electrons and by-products. Fluid containing the electrolyte, the by-products of the electrochemical reaction taking place in the electrochemical cell 10 are output through first outlet 17 of the first fuel cell 10.

The fluid output through first outlet 17 of the first fuel cell 10 is input into second inlet 16′ of the second fuel cell 10′. An electrochemical reaction occurs in the second fuel cell 10′ where at least a portion of the fluid input through second inlet 16′ reacts with fuel particles in the second fuel cell 10′ to produce a flow of electrons and by-products. The fluid containing the electrolyte, and by-products of the electrochemical reaction taking place in the cell 10′ are output through second outlet 17′ of the second fuel cell 10′. Although two fuel cells 10 and 10′ are depicted being connected in fluid flow series, two or more fuel cells can be connected in fluid flow series. For example, a third fuel cell (not shown) can be added to the first and second fuel cells 10 and 10′ such that the second outlet 17′ of the second fuel cell 16′ can be connected to an inlet of the third fuel cell. In this way, the fluid containing the electrolyte and by products of the electrochemical reaction in the fuel cells 10 and 10′ are input into the third fuel cell where yet another electrochemical reaction takes place to generate a flow of electrons and other chemical by-products.

As shown in FIG. 2, the fuel cells 10 and 10′ are also electrically connected in series. The cathode 12 of the first fuel cell 10 can be electrically connected to the anode 14′ of the second fuel cell 10′. The anode 14 of the first fuel cell 10 can be electrically connected through the load L to the cathode 12′ of the second fuel cell 10′. Alternatively, the anode 14 of the first fuel cell 10 can be electrically connected to the cathode 12′ of the second fuel cell 10′ and the cathode 12 of the first fuel cell 10 can be electrically connected to the anode 14′ of the second fuel cell 10′ through the load L. Although two fuel cells 10 and 10′ are depicted being electrically connected in series, two or more fuel cells can be electrically connected in series. For example, a third fuel cell can be added such that the cathode 12 of the first fuel cell 10 can be electrically connected to the anode 14′ of the second fuel cell 10′ and the cathode 12′ of the second fuel cell 10′ can be electrically connected to the anode of the third fuel cell (not shown). The anode 12 of the first fuel cell 10 can be electrically connected to the cathode of the third fuel cell (not shown) through the load L.

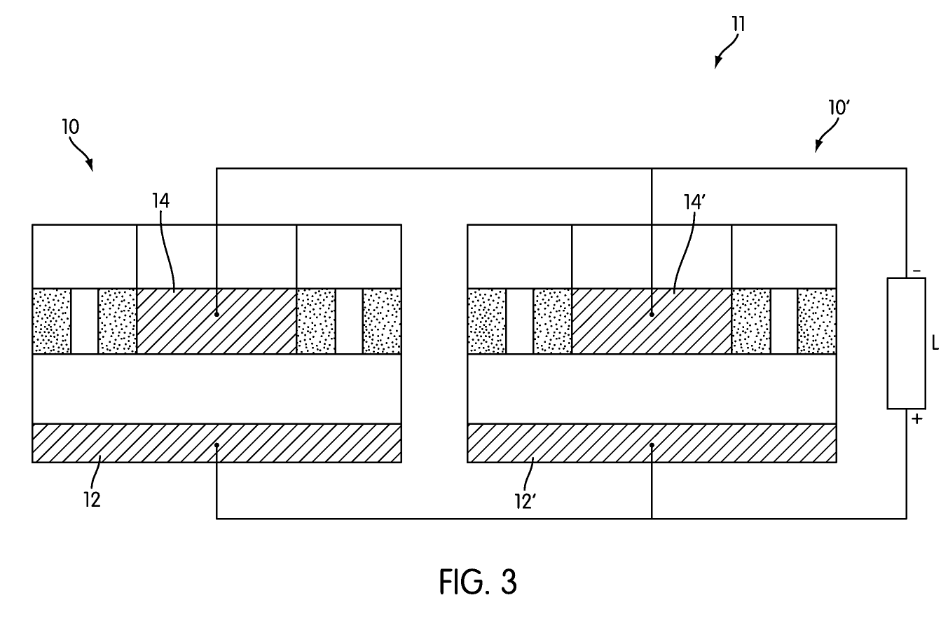

The fuel cells 10 and 10′ can also be electrically connected in parallel. FIG. 3 shows the fuel cells 10 and 10′ connected in parallel, according to another embodiment of the invention. In this case, the anode 14 of the first fuel cell 10 can be electrically connected to the anode 14′ of the second fuel cell 10′ and the cathode 12 of the first fuel cell 10 can be electrically connected to the second cathode 12′ of the second fuel cell 10′. The load L can be connected in parallel to a common electrical point between the anodes 14 and 14′ and to a common electrical point between the cathodes 12 and 12′.

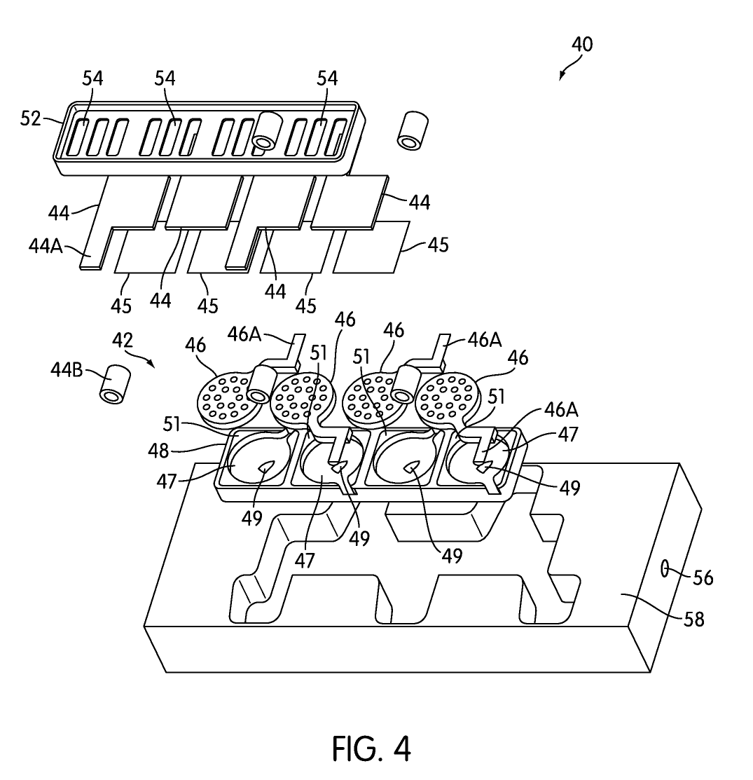

FIGS. 4 and 5 are an exploded, perspective view of an embodiment of an electrochemical cell system that includes four electrochemical fuel cells. FIG. 4 is one side exploded perspective view while FIG. 5 is the opposite side exploded perspective view. The electrochemical system 40 includes four electrochemical fuel cells 42. As described in the previous paragraphs, each fuel cell 42 includes a cathode 44 and an anode 46.

The fuel cell system 40 further includes an anode holder 48 and a cathode holder 52. The anode holder 48 is configured to hold the anodes 46 of the fuel cells 42. In this embodiment, a single anode holder 48 is provided to hold all four anodes 46 of the four fuel cells 42. Alternatively, a plurality of anode holders 48 can also be provided to individually hold each anode 46. The anode holder 48 has a plurality of recesses 47 for receiving the anodes 46. In this embodiment, the anode holder 48 has four recesses for receiving the four anodes 46. The anode holder 48 has a plurality of openings 49 (in this embodiment 4 openings) provided at a bottom of the recesses 47. Each recess 47 has a conical or funnel shape leading to the opening 49. The conical or funnel shape of the recess 47 can allow a homogenous spread of the fluid containing the electrolyte throughout substantially the whole surface of the anode 46. Each opening 49 communicates with a passageway 50 formed in the anode holder 48 on the opposite side of each recess 47. Benefits of providing a passageway 50 with a spiral configuration will be explained further in detail in the following paragraphs.

The anode holder 48 also includes a plurality of return ports 51 that are configured to allow electrolyte and by-products of the electrochemical reactions in one electrochemical fuel cell 42 to flow from the one fuel cell to an adjacent fuel cell. In one embodiment, this can be achieved by connecting a return port 51 of one fuel cell 42 to a passageway 50 of an adjacent fuel cell. Hence, the individual fuel cells in the electrochemical system 40 can be seen as connected in fluid flow series.

In one embodiment, the anode 46 can include a solid body of metal (e.g., zinc or aluminum). The anode is where the fuel of the system is oxidized. The anode 46 comprises the fuel of the system. For example, the fuel can be the metal constituent (e.g. zinc or aluminum) of the body of the anode 46. The anode 46 can be provided with a plurality of opening or holes for allowing the electrolyte to flow through the anode. However, instead of an anode with a solid body, an anode with a porous body can be used. The porous body can be a porous material on which a metal source of fuel, is deposited or captured.

The fuel cell system 40 also includes a cathode holder 52. The cathode holder 52 is configured to hold the cathodes 44. Similar to the anode holder 48, a single cathode holder 40 is provided to hold all four cathodes 44. However, a plurality of cathode holders 52 can be provided to individually hold each cathode 44. The cathode holder 52 comprise a plurality of receiving spaces or receiving cavities 53. Each receiving cavity 53 in the cathode holder 52 is configured to receive each of the plurality of cathodes (in this embodiment 4 cathodes). The cathode holder 52 has a plurality of openings or windows 54 communicating with the receiving cavities 53. In this embodiment, each receiving cavity 53 in the cathode holder 52 is provided with three openings 54. Hence, the cathode holder 52 has a total of 12 openings 54. Although, three openings 54 are provided for each receiving cavity 53, one or more opening can be provided. Each opening 54 extends along width of the cathode holder 52 thus forming a series of ribs that separate the openings 54 and provide more support to each cathode 44. Although the openings 54 are shown having a rectangular shape, the openings 54 can have any other geometrical shape including a polygonal shape, round shape, elliptical shape, or a more complex shape such as a star shape, or any combination of these shapes. The cathode can be disposed inside the receiving cavity 53 so that the cathode can be exposed to the oxidizer through the openings or windows 54. The cathode holder 52 can be made from any suitable non-conductive material, such as plastic or ceramic.

The cathode 44 comprises a porous body covered on one side (the side facing the openings or windows 53) by a gas permeable layer through which an oxidizer may enter or diffuse but preventing the fluid containing the electrolyte to pass therethrough. In other words, the layer is gas permeable but not permeable to a liquid (e.g., the electrolyte). The porous body may also be covered on the opposite side by a liquid permeable layer through which the electrolyte may pass through so that the electrolyte may contact the porous body. The porous body of the cathodes 44 comprises a catalyst material that can have a high activity for an oxidizer reduction reaction. As described in the previous embodiments, the cathode can be a passive or “breathing” cathode that is passively exposed, such as through the windows or openings 54, to an oxidizer source (such as oxygen present in the air). The cathode absorbs the oxidizer for consumption in the electrochemical cell reaction. The cathode can comprise a catalyst material such as manganese oxide, nickel, cobalt, silver, activated carbon, and platinum, or any combination of two or more thereof.

In one embodiment, the fuel cell system 40 can also include a plurality of spacers 45. The spacers 45 are disposed between the cathode 44 and the anode 46. The spacers 45 are configured to space apart the anode 46 and cathode 44 to create a gap through which the electrolyte can flow. In one embodiment, the spacer 45 can be a sheet of non-conductive material, such as plastic (e.g., polypropylene) that can have a plurality of holes so as to allow the fluid containing the electrolyte to reach the cathode 44. In another embodiment, the spacer 45 can be a meshed non-conductive material. In yet another embodiment, the spacer 45 can be a material provided with openings or windows to allow the electrolyte to flow therethrough.

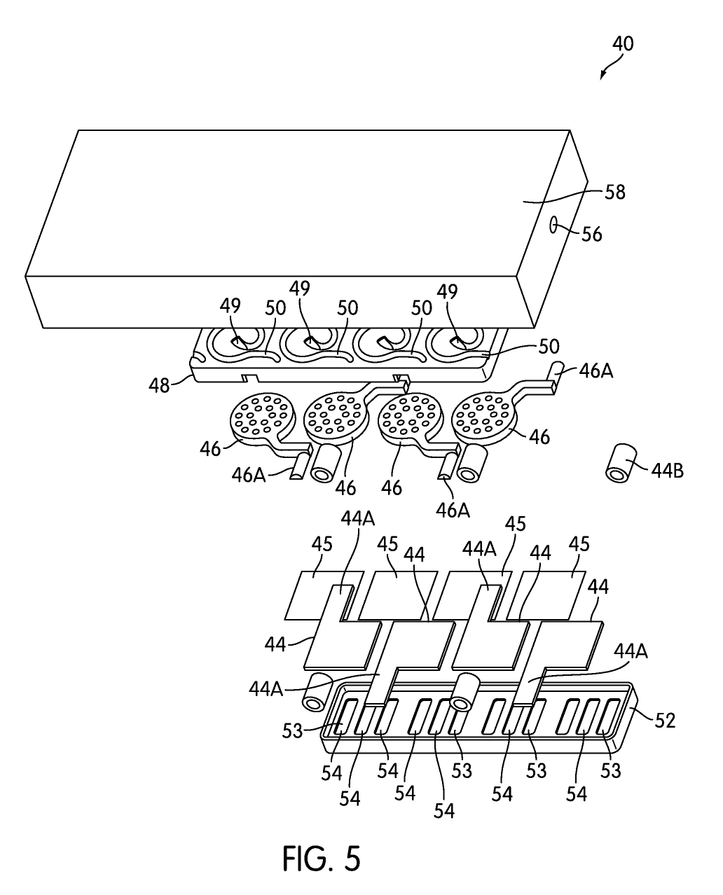

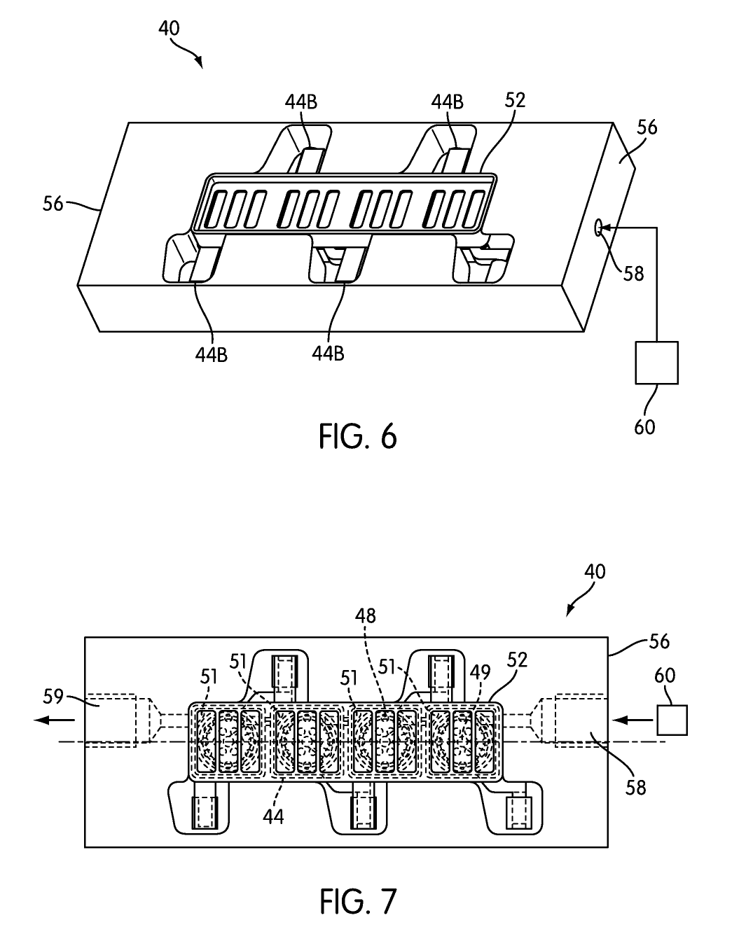

The electrochemical system 40 further comprises a housing 56. The housing 56 is configured to receive the anode holder 48 and the cathode holder 50. FIG. 6 depicts the electrochemical cell system 40 where the anode holder 48 holding the anodes 46 and the cathode holder 52 holding the cathodes 44 are positioned inside the housing 56. FIG. 7 is a top view of the electrochemical cell system 40 depicted in FIG. 6 showing the relative position of the cathode holder 52, cathodes 44 (an outline of which is shown in dotted lines) and anode holder 48 (an outline of the fluid passageway 50 in the anode holder 48 is shown in dotted lines).

As shown in FIGS. 6 and 7, the housing 56 has a fluid inlet port 58 and a fluid outlet port 59. The fluid inlet port 58 is provided to input a fluid containing an electrolyte into the electrochemical cell system 40. A flow generator or pumping system 60 can be provided to pump the fluid including the electrolyte into the electrochemical fuel cell system 40 through fluid inlet port 58. The fluid inlet port 58 is connected to a first passageway 50 in the anode holder 48 for guiding the fluid containing the electrolyte input through the fluid inlet port 58 to a first opening 49 in the anode holder 48. The opening 49 directs the fluid towards the anode 46. Electrochemical reactions occur between the anode 46 and cathode 44 in a first fuel cell 42 where at least a portion of the fluid containing the electrolyte and the fuel (e.g., a metal constituent of the anode body) is consumed and react to produce a flow of electrons and by-products. Fluid containing the electrolyte and by-products of the electrochemical reaction that took place in the first fuel cell 42 are output through a first return port 51 provided in the anode holder 48. The first return port 51 is connected to a second passageway 50 in the anode holder 48. The fluid containing the electrolyte received via the first return port 51 is guided through the second passageway 50 into a second opening 49 in the anode holder 48. Electrochemical reactions occur between the anode 46 and cathode 44 in a second fuel cell 42 where at least a portion of the fluid containing the electrolyte reacts to produce a flow of electrons and by-products. Fluid containing the electrolyte and the by-products of the electrochemical reaction that took place in the second fuel cell 42 are output through a second return port 51 provided in the anode holder 48. This cycle can repeat in a third and fourth fuel cells 42 of the electrochemical system 40. At the end of the cycle in the fourth fuel cell 42, the electrolyte and by-products of the electrochemical reaction can exit the electrochemical cell system 42 via the outlet 59 which is connected to the return port 51 of the fourth fuel cell.

The cathodes 44 and anodes 46 are provided with electrical terminals for connecting the fuel cells 42 electrically in series to a load L. The cathodes 44 are provided with electrical terminals 44A and anodes are provided with electrical terminals 46A. In one embodiment, the electrical terminals 44A and 46A are integrally formed with the cathodes 44 and anodes 46. For example, as shown in FIGS. 4 and 5, the electrical terminals can have a L-shape. In order to connect the 4 fuel cells electrically in series, a terminal 44A of a cathode 44 of a first fuel cell is connected to a terminal 46A of an anode of a second fuel cell, a terminal 44A of a cathode 44 of the second fuel cell is connected to a terminal 46A of an anode 46 of a third fuel cell, and a terminal 44A of a cathode 44 of the third fuel cell is connected to a terminal 46A of an anode 46 of a fourth fuel cell. To close the electrical circuit, the load L can be connected to the terminal 46A of the anode 46 of the first cell (i.e., the anode terminal cell) and to the terminal 44A of the cathode 44 of the fourth cell (i.e., the cathode terminal cell).

Although 4 cells are illustrated as being connected in series, any number (2 or more) of cells can be connected in series. In one embodiment, a cathode electrical terminal 44A can be connected to an anode electrical terminal 46A by clamping together the two terminal using a suitable connector, for example, a crimp connector 44B. However, other means for connecting the terminals of the cathode and anode can also be used. For example, the terminals can be soldered together or a wire can be used to connect the terminals.

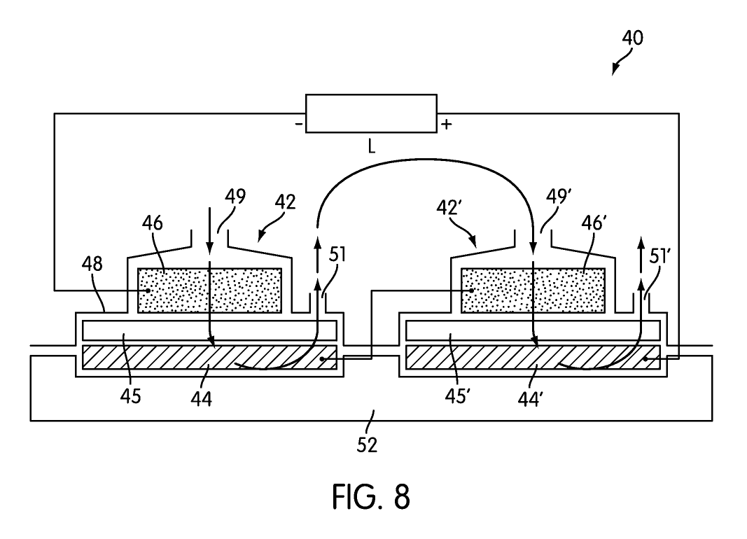

FIG. 8 is a schematic view of the electrochemical fuel cell system 40 with two fuel cells 42 and 42′ connected in fluid flow series in which a fluid containing the electrolyte flows in series over the two fuel cells 42 and 42′, according to an embodiment of the present invention. For illustration purposes, two fuel cells 42 and 42′ are shown connected in fluid flow series and electrically in series. However, it must be appreciated that any number of fuel cells can be configured to be connected in fluid flow series and electrically in series. As illustrated in FIG. 8, a fluid is input into the electrochemical fuel system 40 and passes through inlet 49 of the first fuel cell 42. An electrochemical reaction occurs in the first fuel cell 42 where at least a portion of the fluid containing the electrolyte and the fuel (e.g., provided by the anode 46) is consumed and react to produce a flow of electrons and by-products. Fluid containing the electrolyte and by-products of the electrochemical reaction carried out in the electrochemical cell 42 are output through return 51 of the first fuel cell 42.

The fluid output through return 51 of the first fuel cell 42 is input into inlet 49′ of the second fuel cell 42′. An electrochemical reaction occurs in the second fuel cell 42′ where at least a portion of the fluid input through inlet 49′ of the second fuel cell 42′ reacts to produce a flow of electrons and by-products. The fluid containing the electrolyte and by-products of the electrochemical reaction that took place in the second fuel cell 42′ are output through return 51′ of the second fuel cell 42′.

As shown in FIG. 8, the fuel cells 42 and 42′ are also electrically connected in series. The cathode 44 of the first fuel cell 42 can be electrically connected to the anode 46′ of the second fuel cell 42′. The anode 46 of the first fuel cell 42 can be electrically connected through the load L to the cathode 44′ of the second fuel cell 42′. Alternatively, the anode 46 of the first fuel cell 42 can be electrically connected to the cathode 44′ of the second fuel cell 42′ and the cathode 44 of the first fuel cell 42 can be electrically connected to the anode 46′ of the second fuel cell 42′ through the load L.

The fuel may be a metal, such as iron, zinc, aluminum, magnesium, or lithium. By metal, this term is meant to encompass all elements regarded as metals on the periodic table, including but not limited to alkali metals, alkaline earth metals, lanthanides, actinides, and transition metals, either in atomic or molecular form when collected on the electrode body. However, the present invention is not intended to be limited to any specific fuel, and others may be used. For example, the fuel may include oxidizable organic solids or immiscible liquid fuel micelles. The fuel may be provided to the electrochemical cell system as particles. For example, the fuel may be flakes, small spheres, or dendrites of zinc. The amount of fuel particles that are provided to the electrochemical cell system depends on the amount of particles still located in the anode. For example, if there are enough fuel particles in the anode to create the desired amount of electricity, then no additional fuel particles need to be provided to the anode. However, if the amount of fuel particles becomes depleted to a level where the performance of the electrochemical cell decreases by a noticeable amount, the anode may be refueled by providing additional fuel particles. Once the fuel particles are collected at the anode in the porous body, the performance of the electrochemical cell may resume to its desired operating level. In one embodiment, a suitable controller may be provided to monitor the power output and control the feeding of the fuel particles. Alternatively, a solid body of metal fuel can be provided. For example, the solid body of the anode can be used as a source of a fuel.

The electrolyte may be an aqueous solution. Examples of suitable electrolytes include aqueous solutions comprising chlorides, sulfates, sulfuric acid, phosphoric acid, triflic acid, nitric acid, potassium hydroxide, sodium hydroxide, sodium chloride, potassium nitrate, alpha-Al₂O₃, or lithium chloride. The electrolyte may also use a non-aqueous solvent or an ionic liquid. In the non-limiting embodiment described herein, the electrolyte is aqueous potassium hydroxide. The electrolyte may also be an ionic liquid, such as a low temperature ionic liquid having a melting point at or below 150° C. at 1 atm., or a room temperature ionic liquid having a melting point at or below 100° C. at 1 atm. (See U.S. Provisional Application Ser. No. 61/177,072, the entirety of which is incorporated herein).

To limit or suppress hydrogen evolution at the anode, salts may be added to retard such a reaction. Salts of stannous, lead, copper, mercury, indium, bismuth, or any other material having a high hydrogen overpotential may be used. In addition, salts of tartrate, phosphate, citrate, succinate, ammonium or other hydrogen evolution suppressing additives may be added. In an embodiment, metal fuel alloys, such as Al/Mg may be used to suppress hydrogen evolution.

One example of electrochemical reactions that can take place in the fuel cell 10, 42 when using potassium hydroxide as the electrolyte (which is alkaline), zinc (Zn) as the fuel, and oxygen (O₂) from ambient air as the oxidizer, can be described as follows:

In a case of a single cell configuration where a load is connected to the cathode and to the anode of the fuel cell, chemical reactions can be expressed as follows. At the anode, the zinc is oxidized (in the presence of KOH), as represented by equation (1):

Zn+4OH⁻→Zn(OH)₄²⁻+2e⁻(E^{o}=−1.216V) (1)

At the cathode, oxygen is reduced, as represented by equation (2):

2e⁻+½O₂+H₂O→2OH⁻(E^{o}=0.401V) (2)

In solution, the following reaction occurs as represented by equation (3):

Zn(OH)₄²⁻→ZnO+H₂O+2OH⁻ (3)

Thus, the zinc is oxidized at the anode and its positive ion (Zn²⁺) is supported by four OH⁻ ions to create the complex anion (zincate anion) Zn(OH)₄²⁻. The concentration of OH⁻ ions in the electrolyte solution is maintained by the oxidizer reduction reaction at the cathode and the release of the OH⁻ ions from reaction of the Zn(OH)₄²⁻ anion. The electrolyte flow transports the relatively unstable Zn(OH)₄²⁻ ion away from the anode, thus preventing the zinc ion Zn²⁺ from reducing back to zinc at the anode (which in turn improves efficiency, as electrons are free to flow through the load L rather being consumed by reduction of the zincate anion). In the electrolyte, the complex Zn(OH)₄²⁻ anion reacts in the solution to provide water (H₂O), OH⁻ ions, and zinc oxide (ZnO), which is present in the electrolyte. The zinc oxide (ZnO) is formed by the removal of two of the OH⁻ ions from the zincate anion (Zn(OH)₄²⁻), the remaining two OH⁻ ions react to form one water molecule (H₂O) and the ZnO product.

Thus, the overall reaction between the reduced oxidizer (OH⁻) ions and the oxidized zinc (Zn²⁺) ions provides the intermediate by-product of Zn(OH)₄²⁻, which ultimately reacts (e.g., dissociates) to become zinc oxide (ZnO). As can be seen from the representative reaction equations set forth above, the remaining constituents of the reactions balance out (i.e., they are consumed or created in equal amounts). Thus, in its simplest form of expression, the overall reaction at the anode reduces the oxidizer at the cathode with electrons received from the load, oxidizes the fuel particles at the anode to supply electrons to the load, and reacts the reduced oxidizer ion and oxidized fuel ions to form a by-product, in this case zinc oxide. The transport flow in the direction from the anode towards the cathode helps support and drive this process and increases the overall power output.

Additional intermediary reactions may occur at the anode and/or the cathode and/or in the gap, and the described reactions are not intended to be exclusive of any side or intermediary reaction. Also, the reactions are representative and may be expressed differently, but the general overall reaction results in the oxidation of zinc and reduction of oxygen to produce the by-product of zinc oxide (ZnO) and electrical current that drives the load L. The zinc oxide by-product may flow out of the electrochemical cell with the electrolyte. As an option, the zinc oxide may be recovered from the flow and the zinc may be separated and reintroduced into the fuel and electrolyte source.

In the case of the electrochemical cell system 40 depicted schematically in FIG. 8, electrons generated at the anode 46 of the first fuel cell 42 from the electrochemical reactions taking place in the first fuel cell 42 flow to the cathode 44′ of the second fuel cell 42′ through the load L. At the cathode 44′ of the second fuel cell 42′, the electrons from the anode 46 of the first fuel cell 42 that passed through the load L, and the oxygen from the air form OH⁻ ions in solution. The electrons generated at the anode 46′ of the second fuel cell 42′ from the electrochemical reactions taking place in the second fuel cell 42′ flow to the cathode 44 of the first fuel cell 42 via the short circuit electrical connection between the cathode 44 of the first fuel cell 42 and the anode 46′ of the second fuel cell 42′. These electrons are supplied to the cathode 44 of the first fuel cell 42 to react with the oxygen in the air to form OH⁻ ions in solution.

As stated above, the electrolyte flow transports the relatively unstable Zn(OH)₄²-ion away from the anode thus preventing the zinc ion Zn²⁺ from reducing back to zinc at the anode. In the case of the electrochemical system 40 shown in FIG. 8, the flow of electrolyte can also transport the relatively unstable Zn(OH)₄²⁻ ion away from the anode 46 of the first fuel cell 42 towards the cathode 44 of the first fuel cell 42. Zn(OH)₄²⁻ ion can dissociate to produce the by-product zinc oxide and OH⁻ ions along the flow pathway. The transport of the relatively unstable Zn(OH)₄²⁻ ion away from the anode 46 of the first fuel cell 42 can prevent the zinc ion Zn²⁺ from reducing back to zinc at the anode 46 (which in turn improves efficiency, as electrons are free to flow through the load L rather being consumed by reduction of the zincate ion). However, because the anode 46′ of the second fuel cell 42′ is fluidly connected to the cathode 44, the Zn(OH)₄²⁻ ion may reach the anode 46′ of the second fuel cell 42′. As a result, zinc ion Zn²⁺ from Zn(OH)₄²⁻ ion may be reduced back to zinc in the vicinity of the anode 46′ which may decrease the effectiveness of the anode 46′ by consuming the electrons generated at the anode 46′ (i.e., a parasitic or internal loss). In order to reduce the likelihood of the Zn(OH)₄²⁻ formed at the anode 46 of the first fuel cell 42 from reaching the anode 46′ of the second fuel cell 42′, the fluid pathway between the first fuel cell 42 and the second fuel cell 42′ can be made longer than the fluid pathway within the first fuel cell 42 or the second fuel cell 42′. For example, the passageway 50 (shown in FIG. 5) can be made longer than the gap between the anode 46 and cathode 44 of the first fuel cell 42. In one embodiment, this can be accomplished by providing a passageway 50 with a spiral configuration (as shown in FIG. 5). The length of the passageway 50 is greater than the gap between the anode 46 and cathode 44. The spiral configuration shown in the Figures (which may also be called Q-shaped) is beneficial because it increases the length of the passageway without having to unnecessarily increase the actual distance between the cells, and has smooth curves that avoid the introduction of substantial head loss in the flow. As can be seen, the passageway 50 almost entirely encircles the inlet 49. The illustrated encircling is about 90%, but the extent of encircling could be any value above 25%. Indeed, the inlet could be encircled more than once so that the encircling is greater than 100%. Although a spiral configuration is depicted in FIG. 5, it can be appreciated that any configuration such as a tortuous, meandering pathway can be used.

In one embodiment, the length and/or cross-section of the passageway 50 are sized such that an ionic resistance between a pair of fluidly connected electrochemical cells is greater than an ionic resistance within one electrochemical cell in the pair of electrochemical cells.

In one embodiment, the length of the passageway 50 can be selected to be greater than 10 times the dimension of the gap between the anode 46 and cathode 44, for example greater than 15 times the dimension of the gap.

In one embodiment, the length of the passageway 50 can be selected greater than the size of the gap between the cathode 44 and anode 46 so as to reduce or minimize internal ionic resistance (IR) loss to less than 15%. In another embodiment, the length of the passageway 50 can be selected greater than the size of the gap between the cathode 44 and anode 46 so as to reduce or minimize internal ionic resistance (IR) loss to less than 10%. In yet another embodiment, the length of the passageway 50 can be selected greater than the size of the gap between the cathode 44 and anode 46 so as to reduce or minimize internal ionic resistance (IR) loss to less than 5%. The IR loss can be minimized, for example, by optimizing a flow of electrolyte within the passageway 50 to achieve a certain electrolyte flow rate within the passageway 50. The IR loss can also be minimized by selecting an appropriate ratio of a smallest cross-sectional dimension in the passageway 50 to a length of the passageway 50.

In the case the electrochemical cell system 40 where a plurality of fuel cells 42 are connected in “fluid series,” by-products may be formed in each fuel cell 42. In one embodiment, the by-product (e.g., ZnO) can be transported by the fluid flow from fuel cell 42 to adjacent fuel cell 42 before exiting the electrochemical cell system via the outlet 59. The by-product (e.g., ZnO) can then be recovered from the fluid output via outlet 59. In another embodiment, the by-product (e.g., ZnO) can be recovered at each exit from each fuel cell 42 via return 51 before entering into a next fuel cell 42.

Although the directional flow in the anode-cathode direction helps increase the power output, in certain situations or applications, it may be desirable to cease the flow. Even when the flow is stopped, some power may be generated, although the power output would be significantly less than when the electrolyte is flowing and transporting the oxidized fuel ions away from the anode and towards the cathode. This “passive operation” state with no or essentially no flow may be useful for powering devices with a standby mode (e.g., a laptop computer) or some other mode where only a small amount of power is required. A suitable controller may be used to control whatever flow generator is provided for generating the flow to switch between this passive state and an active state where the transport flow is present.

With another fuel and/or oxidizer, the reaction may occur differently, but the overall result is oxidation of fuel and reduction of oxidizer to generate a flow of electrons. Other types of by-products may be formed. For example, aluminum may be used to comprise the fuel, and the reactions would be different. Thus, any of the discussion herein where zinc is mentioned as the fuel may apply to other fuels and particularly to aluminum.

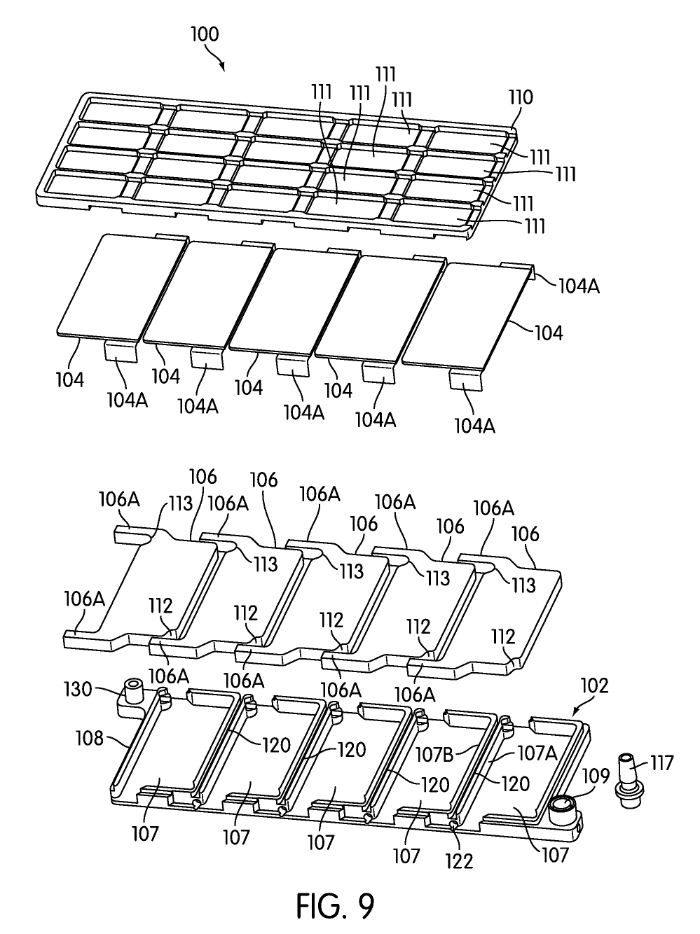

FIG. 9 is an exploded, perspective view of another embodiment of an electrochemical cell system 100 that includes five electrochemical fuel cells 102. Each fuel cell 102 includes a cathode 104 and an anode 106.

In one embodiment, the anode 106 can include a solid body of metal (e.g., zinc or aluminum) (such as for battery embodiments). The anode is where the fuel of the system is oxidized. The anode 106 comprises the fuel of the system. For example, the fuel can be the metal constituent of the body of the anode 106. The fuel may be a metal, such as iron, zinc, aluminum, magnesium, or lithium. By metal, this term is meant to encompass all elements regarded as metals on the periodic table, including but not limited to alkali metals, alkaline earth metals, lanthanides, actinides, and transition metals, either in atomic or molecular form when collected on the electrode body. However, the present invention is not intended to be limited to any specific fuel, and others may be used.

In the illustrated embodiment, the body of the anode 106 has generally a rectangular shape with two arms 106A extending therefrom. The arms 106A of the anode 106 can be used as electrodes or electrical terminals. Although the body of the anode 106 is illustrated herein having generally a rectangular shape, the body of the anode can have any desired shape such as a circular or disk shape, a polygonal shape or any other more complex shape. In the illustrated embodiment, the body of the anode 106 includes a notch 112 provided on a corner of the rectangular shaped body of the anode 106. The body of the anode 106 also includes a recess 113 provided diagonally opposite to the notch 112 on one side of one arm 106A in the body of the anode 106.

The cathode 104 comprises a porous body covered on one side by a gas permeable layer through which an oxidizer (e.g., oxygen present in the air) may enter or diffuse but preventing the fluid containing the electrolyte to pass therethrough. In other words, the layer is gas permeable but not permeable to a liquid (e.g., the electrolyte). The porous body may also be covered on the opposite side by a liquid permeable layer through which the electrolyte may pass through so that the electrolyte may contact the porous body. The porous body of the cathodes 104 comprises a catalyst material that can have a high activity for an oxidizer reduction reaction. As described in the previous embodiments, the cathode can be a passive or “breathing” cathode that is passively exposed to an oxidizer source (such as oxygen present in the air). The cathode absorbs the oxidizer for consumption in the electrochemical cell reaction. The cathode can comprise a catalyst material such as manganese oxide, nickel, silver, cobalt, activated carbon, and platinum, or any combination of two or more thereof. Each cathode 104 includes a pair of arms 104A extending from the body of the cathode 104. The arms 104A can be used as electrodes or electrical terminals.

In one embodiment, the fuel cell system 100 can optionally include a one or more spacers (not shown). The spacers can be disposed between the cathode 104 and the anode 106. The spacers can be configured to space apart the anode 106 and cathode 104 to create a gap between the anode 106 and cathode 104 through which a fluid electrolyte can flow. The spacers also allow to electrically isolate the anode 106 from the cathode 104 within one electrochemical fuel cell 102. For example, the spacer can be a sheet of non-conductive material, such as plastic (e.g., polypropylene) that can have a plurality of holes so as to allow the fluid containing the electrolyte to pass between the anode 106 and cathode 104. Instead of a sheet, the spacer can also be a meshed non-conductive material or a material provided with openings or windows to allow the electrolyte to flow therethrough (such as a latticed structure).

The fuel cell system 100 further includes an anode holder 108 and a cathode holder 110. The anode holder 108 is configured to hold the anodes 106 of the electrochemical fuel cells 102. In this embodiment, a single anode holder 108 is provided to hold all five anodes 106 of the five electrochemical fuel cells 102. Alternatively, a plurality of anode holders 108 can also be provided to individually hold each anode 106. The anode holder 108 has a plurality of cavities 107 for receiving the anodes 106. In this embodiment, the anode holder 108 has five cavities 107 for receiving the five anodes 106. The anode holder 108 has an inlet port 109 that can be fitted with a port fitting 111 for connecting to a fluid flow generator or pumping system (not shown) to provide a fluid containing an electrolyte into the electrochemical cell system 100.

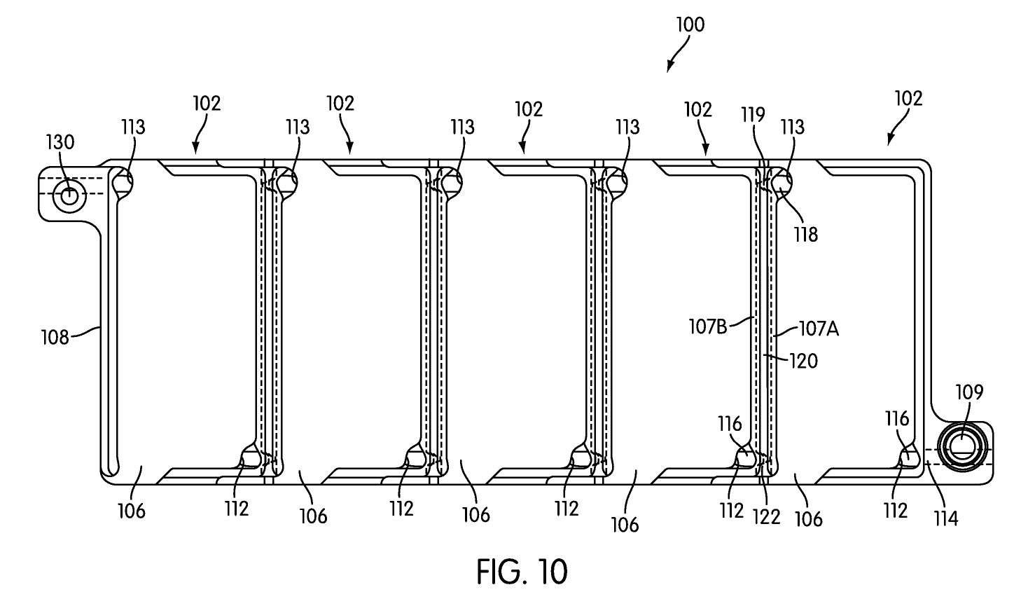

FIG. 10 is an elevation view of the electrochemical cell system 100 showing the anodes 106 disposed within the cavities 107 of the anode holder 108. As shown in FIGS. 9 and 10, the inlet port 109 is in fluid communication with the cavity 107 of a first fuel cell 102 through a channel 114 (shown in dotted lines in FIG. 10). The fluid containing the electrolyte input through the input port 109 and transported through the channel 114 is guided through an opening 116 formed by the notch 112 in the first anode 106 and a portion of a wall of the cavity 107. The fluid flows from the opening 116 (shown in FIG. 10) into a gap between the first anode 106 and a corresponding first cathode 104. Electrochemical reactions occur between the anode 106 and cathode 104 in the first fuel cell 102 where at least a portion of the fluid containing the electrolyte reacts to produce a flow of electrons and by-products. Fluid containing the electrolyte and the by-products of the electrochemical reaction that took place in the first fuel cell 102 is output through a return port 118 formed by the recess 113 and a portion of a wall of the cavity 107 and located diagonally opposite to the opening 116. The fluid containing the electrolyte and by-products of the electrochemical reaction then traverses through an opening 119 provided in a sidewall 107A of the cavity 107 in the vicinity of the return port 118 and flows into a channel or groove 120 between two adjacent sidewalls 107A and 107B of two adjacent cavities 107 in the anode holder 108. The channel or groove 120 runs along length of the cavity 107 in fuel cell 102. The fluid containing the electrolyte and by-products of the electrochemical reaction then penetrates through an opening or hole 122 into a channel 116 (shown in FIG. 10) formed by the notch 112 in the anode 106 of a second fuel cell 102 and a portion of a wall of the second cavity 107. This cycle can repeat in the second, third, fourth and fifth fuel cells 102 of the electrochemical system 100. At the end of the cycle in the fifth fuel cell 102, the electrolyte and by-products of the electrochemical reaction can exit the electrochemical fuel cell system through output port 130. Hence, the individual fuel cells 102 in the electrochemical system 100 are connected in fluid flow series.

The cathode holder 110 is configured to hold the cathodes 104. Similar to the anode holder 108, a single cathode holder 110 is provided to hold all five cathodes 104. However, a plurality of cathode holders 110 can be provided to individually hold each cathode 104. The cathode holder 110 comprises a plurality of receiving spaces. Each receiving space in the cathode holder 110 is configured to receive each of the plurality of cathodes (in this embodiment 5 cathodes). The cathode holder 110 has a plurality of openings or windows 111 communicating with the receiving spaces. In the illustrated embodiment, each receiving space for receiving the cathode 104 has four windows 111. Hence, the cathode holder 110 has a total of 20 windows 111. Although, four windows 111 are provided for each receiving cavity, one or more window can be provided. Thus, any number of windows 111 can be provided. Although the windows 111 are shown having a rectangular shape, the windows 111 can have any other geometrical shape including a polygonal shape, round shape, elliptical shape, or a more complex shape such as a star shape, or any combination of these shapes. The cathode 104 can be disposed inside the receiving space so that the cathode can be exposed to the oxidizer through the openings or windows 111. The cathode holder 110 can be made from any suitable non-conductive material, such as plastic or ceramic.

As shown in FIG. 9, the cathodes 104 and the anodes 106 are provided with electrical terminals 104A and 106A for connecting the fuel cells 102 electrically in series or in parallel to a load L. The electrical terminals 104A and 106A are integrally formed with the cathodes 104 and anodes 106. For example, in order to connect the 5 fuel cells electrically in series, a terminal 104A of a cathode 104 of a first fuel cell 102 is connected to a terminal 106A of an anode 106 of a second fuel cell 102, a terminal 104A of a cathode 104 of the second fuel cell 102 is connected to a terminal 106A of an anode 106 of a third fuel cell 102, a terminal 104A of a cathode 104 of the third fuel cell 102 is connected to a terminal 106A of an anode 106 of a fourth fuel cell, and a terminal 104A of a cathode 104 of the fourth fuel cell 102 is connected to a terminal 106A of an anode 106 of a fifth fuel cell. To close the electrical circuit, the load L can be connected to the terminal 106A of the anode 106 of the first cell (i.e., the anode terminal cell) 102 and to the terminal 104A of the cathode 104 of the fifth cell (i.e., the cathode terminal cell) 102.

Although five electrochemical fuel cells are illustrated as being connected in electrical series, any number (2 or more) of cells can be connected in series. In the embodiment illustrated, a cathode electrical terminal 104A can be connected to an anode electrical terminal 106A by clamping together the two terminals within the anode holder 108. Indeed, the anode terminals 106A and cathode terminals 104 are configured such that, for example, the cathode terminals 104A of the cathode 104 in the second fuel cell is brought in electrical contact with the anode terminals 106A of the anode 106 of the first fuel cell. By configuring and arranging the terminals 106A and 104A as depicted in FIG. 9, the cathode terminals 104A and anode terminals 106A contact each other when the anodes 106 and cathodes 104 are mounted within their respective housings, i.e., holders 108 and 10. However, as it can be appreciated, other means for connecting the terminals of the cathode and anode can also be used. For example, the terminals can be soldered together or a wire can be used to connect the terminals.

One example of electrochemical reactions that can take place in the fuel cell 102 when using potassium hydroxide as the electrolyte and zinc as the fuel, and oxygen from ambient air as the oxidizer are described in the above paragraphs. In the case of the electrochemical cell system 100 depicted schematically in FIGS. 9 and 10, electrons generated at the anode 106 of the first fuel cell 102 from the electrochemical reactions taking place in the first fuel cell 102 flow to the cathode 104 of the fifth fuel cell 102 through the load L. At the cathode 104 of the fifth fuel cell 102, the electrons from the anode 106 of the first fuel cell 102 that passed through the load L, and the oxygen from the air form OH⁻ ions in solution. The electrons generated at the anode 106 of the fifth fuel cell 102 from the electrochemical reactions taking place in the fifth fuel cell 102 flow to the cathode 104 of the fourth fuel cell 102 via the series electrical connection between the cathode 104 of the fourth fuel cell 102 and the anode 106 of the fifth fuel cell 102. The electrons generated at the anode 106 of the fourth fuel cell 102 from the electrochemical reactions taking place in the fourth fuel cell 102 flow to the cathode 104 of the third fuel cell 102 via the series electrical connection between the cathode 104 of the third fuel cell 102 and the anode 106 of the fourth fuel cell 102, and so on. Finally, the electrons generated at the anode 106 of the second fuel cell 102 from the electrochemical reactions taking place in the second fuel cell 102 flow to the cathode 104 of the first fuel cell 102 via series electrical connection between the cathode 104 of the first fuel cell 102 and the anode 106 of the second fuel cell 102.

Another example of electrochemical reactions that can take place in the fuel cell 102 when using potassium hydroxide as the electrolyte (which is alkaline), Aluminum (Al) as the fuel, and oxygen (O₂) from ambient air as the oxidizer, can be described as follows:

In a case of a single cell configuration where a load is connected to the cathode and to the anode of the fuel cell, chemical reactions can be expressed as follows. At the anode, the Aluminum is oxidized (in the presence of KOH), the aluminum reacts with OH⁻ ions to form aluminum hydroxide and release three electrons, as represented by equation (4):

Al+3OH⁻→Al(OH)₃+3e⁻(E^{o}=−2.31V) (4)

At the cathode, oxygen is reduced, the water in the electrolyte reacts with oxygen from air, and absorbs the electrons produced at the aluminum electrode, as represented by equation (5):

O₂+2H₂O+4e⁻→4OH⁻(E^{o}=0.401V) (5)

In solution, the following total reaction is represented by equation (6):

4Al+3O₂+6H₂O→4Al(OH)₃(E^{o}=2.71V) (6)

The electrons produced at the aluminum electrode (the anode) pass through an external circuit through a load connected the electrochemical fuel cell and both reactions (4) and (5) carry on until the aluminum is used up or the circuit is broken.

The energy density of the aluminum/air electrochemical fuel cell is greater than the energy density of the zinc/air electrochemical fuel cell. Reactions take place between the electrolyte and the aluminum to produce by-products such as the aluminum hydroxide that can be released into the fluid electrolyte as a precipitate. The aluminum hydroxide can be removed from the electrolyte fluid by using a filtration system, as discussed previously.

The electrolyte flow may transport the fuel hydroxide ion away out of the gap between the anode and the cathode thus preventing the fuel ion from reducing back to fuel at the anode. As discussed in the previous paragraphs, the internal ionic resistance (IR) loss can be minimized by selecting an appropriate geometry for the channel 120 and/or selecting an appropriate flow rate of electrolyte within the channel 120.

In the case the electrochemical cell system 100 where a plurality of fuel cells 102 are connected in “fluid series,” by-products may be formed in each fuel cell 102. In one embodiment, the by-product (e.g., ZnO, Al(OH)₃) can be transported by the fluid flow from fuel cell 102 to adjacent fuel cell 102 before exiting the electrochemical cell system 100 via the outlet 130. The by-product (e.g., ZnO) can then be recovered from the fluid electrolyte output via outlet 130 by using a filtration system before reintroducing the fluid electrolyte into the electrochemical cell system 100.

In designing the various parts, the structures and various channels can be manufactured on the microfluidic scale to achieve a small, compact size, which is best suited to portability. Various techniques from the formation of microelectronics may be used, such as lithography, thin film deposition, electrochemical processing, and microfluidic processing methodologies may be used. These techniques may be used to enable large scale manufacturing of electrochemical cells designed in accordance with the present invention.

An electrochemical cell constructed in accordance with this invention, including any embodiment described above or below, may be used in portable applications, such as for powering laptops, cell phones, portable audio players, wireless e-mail devices, medical equipment or devices, or any other device for which portability by a person is desirable. However, it should be understood that the present invention may be practiced on larger scale, non-portable devices, and the advantage of portability is not intended to be limiting. To the contrary, the present invention is not limited to portability, but it is believed to be particularly useful for achieving portability.

In some embodiments, the cathode need not be of the air breathing type. The cathode could be porous, and the oxidizer could be delivered to the porous cathode in a solution, such as an electrolyte solution. Thus, the air breathing cathode embodiments are not intended to be limiting.

In any embodiment, the electrochemical cell system may be constructed as a battery comprising a series of individual cells connected fluidly and electrically in the same manner. The cells may be rechargeable (i.e., constituting a secondary cell system) or non-rechargeable (i.e., constituting a primary cell system). Thus, the fuel need not be supplied from an external source, which the term fuel cell conventionally implies, and the term electrochemical cell generically covers fuel cell and battery architectures.

Any embodiment of the present invention, including any embodiment described or mentioned herein, may be practiced with the technologies disclosed in any one or more of the following patent applications: U.S. patent application Ser. No. 12/385,489 (describing a fuel electrode of spaced apart bodies for controlled electrodeposition of fuel in the re-charging of a battery), U.S. patent application Ser. No. 12/549,617 (describing capture of evolved oxygen during cell-recharging), U.S. Provisional Application No. 61/243,970 (describing bypass and switching system for cells connected in series), and U.S. Provisional Application No. 61/249,917 (describing structure for managing precipitate tolerance within a cell). Each of these applications is hereby incorporated herein by reference.

The foregoing illustrated embodiments have been provided solely for illustrating the structural and functional principles of the present invention and are not intended to be limiting. For example, the present invention may be practiced using different fuels, different oxidizers, different electrolytes, and/or different overall structural configuration or materials. Thus, the present invention is intended to encompass all modifications, substitutions, alterations, and equivalents within the spirit and scope of the following appended claims.

It should be appreciated that in one embodiment, the drawings herein are drawn to scale (e.g., in correct proportion). However, it should also be appreciated that other proportions of parts may be employed in other embodiments.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. An electrochemical cell system for generating electrical power, the electrochemical cell system comprising:
a plurality of fluidly connected electrochemical cells, each electrochemical cell comprising:
an anode configured to permit a fluid comprising at least an electrolyte to flow in contact therewith to oxidize a fuel; and
a cathode permeable to an oxidizer, the cathode being configured to receive electrons to reduce the oxidizer; the cathode and the anode being spaced apart to define a gap therebetween for receiving the fluid flow;
wherein the plurality of electrochemical cells are connected in fluid flow series such that, for each pair of fluidly connected electrochemical cells, the fluid flows from a first cell of the pair of cells to a second cell of the pair of cells,
wherein the plurality of electrochemical cells are connected electrically in series such that, for each pair of fluidly connected electrochemical cells, the cathode of the first cell of the pair is electrically connected to the anode of the second cell of the pair, and
wherein an ionic resistance between the pair of fluidly connected electrochemical cells is greater than an ionic resistance within one electrochemical cell in the pair of cells.

2. The electrochemical cell system of claim 1, wherein the anode comprises a solid body of metal.

3. The electrochemical system of claim 2, wherein the metal is selected from the group consisting of zinc, iron, magnesium, aluminum, lithium, and any combination of two or more thereof.

4. The electrochemical cell system of claim 1, wherein the electrolyte comprises at least one aqueous solution selected from the group consisting of sulfuric acid, phosphoric acid, triflic acid, nitric acid, potassium hydroxide, sodium hydroxide, sodium chloride, potassium nitrate, lithium chloride, and any combination of two or more thereof.

5. The electrochemical cell system according to claim 4, wherein the electrolyte comprises potassium hydroxide.

6. The electrochemical cell system of claim 1, wherein the anode comprises a porous body configured to filter fuel particulates from the electrolyte for collecting the fuel thereon.

7. The electrochemical cell system of claim 6, wherein the fuel particulates include particulates selected from the group consisting of zinc, iron, magnesium, aluminum, lithium, and any combination of two or more thereof.

8. The electrochemical cell system of claim 1, wherein the cathode is a gas permeable electrode having an outer surface exposed to ambient air such that the oxidizer comprises oxygen that permeates the cathode.

9. The electrochemical cell system of claim 8, wherein the cathode comprises a barrier membrane on the outer surface thereof that is gas permeable and liquid impermeable so as to permit permeation of the oxidizer via the outer surface of the cathode and prevent the electrolyte from flowing through the outer surface of the cathode.

10. The electrochemical cell system of claim 1, wherein the cathode comprises a catalytic material selected from the group consisting of manganese oxide, nickel, cobalt, activated carbon, silver, platinum, and any combination of two or more thereof.

11. The electrochemical cell system of claim 1, further comprising a plurality of spacers, each of the spacers being disposed between the anode and the cathode of each of the plurality of electrochemical cells so as to space apart the anode and the cathode to create a gap through which the fluid containing the electrolyte flows.

12. The electrochemical system of claim 1, further comprising an anode holder configured to hold the anode of each of the plurality of electrochemical cells,
wherein the anode holder includes a plurality of inlets for introducing the fluid into the plurality of electrochemical cells, and a plurality of return ports to allow fluid introduced into each of the plurality of electrochemical cells to exit the plurality of electrochemical cells, wherein each inlet in the plurality of inlets and each return port in the plurality of return ports is associated with one electrochemical cell in the plurality of electrochemical cells.

13. The electrochemical system of claim 12, wherein the anode holder includes a plurality of recesses configured to receive the anode of each of the plurality of electrochemical cells, wherein each of the plurality of inlets and each of the plurality of return ports communicate with each of the plurality of recesses.

14. The electrochemical system of claim 13, wherein the anode holder further includes a plurality of passageways in communication with the plurality of return ports, the passageways being provided opposite the plurality of recesses, each passageway being associated with one electrochemical cell in the plurality of electrochemical cells.

15. The electrochemical system of claim 14, wherein, for each adjacent pair of electrochemical cells, a return channel in the first electrochemical cell of the pair is in communication with an inlet in the second electrochemical cell of the pair via a passageway in the second electrochemical cell of the pair.

16. The electrochemical cell system of claim 14, wherein the passageways have a tortuous, spiral or meandering configuration.

17. The electrochemical cell system of claim 14, wherein the passageways are longer than a gap between the anode and cathode.

18. The electrochemical cell system of claim 13, wherein each of the plurality of recesses has a conical shape for homogenizing a fluid flow throughout the anode in each of the plurality of electrochemical cells.

19. The electrochemical cell system of claim 1, further comprising a cathode holder configured to hold the cathode.

20. The electrochemical cell system of claim 1, further comprising one or more flow generators configured to generate the flow of fluid containing the electrolyte across the anode towards the cathode to transport oxidized fuel ions within the electrolyte away from the anode towards the cathode and to transport at least the electrolyte and by-products formed by reaction of the oxidized fuel ions and reduced oxidizer ions away from the gap.

21. The electrochemical cell system of claim 1, wherein the fluid flows from an anode of the first cell into the gap towards a cathode of the first cell and from the first cell to an anode of the second cell.

22. The electrochemical cell system of claim 1,
wherein the plurality of electrochemical cells are connected in fluid flow series such that, for each pair of fluidly connected electrochemical cells, the fluid flows from the gap in the first cell of the pair of cells towards a fluid channel formed between the pair of cells and from the fluid channel towards the gap in the second cell of the pair of cells.

23. The electrochemical system of claim 22, further comprising an anode holder configured to hold the anode of each of the plurality of electrochemical cells,
wherein the anode holder includes a fluid input port for introducing the fluid into the plurality of electrochemical cells, a fluid output port to allow the fluid to exit the plurality of electrochemical cells, and a plurality of return ports to allow fluid introduced into each of the plurality of electrochemical cells to exit each of the plurality of electrochemical cells and to enter the fluid channel between the pair of cells in the plurality of electrochemical cells.

24. The electrochemical system of claim 23, wherein the anode holder includes a plurality of cavities configured to receive the anode of each of the plurality of electrochemical cells, wherein each of the plurality of return ports communicates with each of the plurality of cavities.

25. The electrochemical system of claim 24, wherein the fluid channel formed between the pair of cells is in communication with a return port of one of the pair of cells.

26. The electrochemical cell system of claim 25, wherein the fluid channel runs along a length of a cavity between two adjacent cavities in the plurality of cavities.

27. The electrochemical cell system of claim 26, wherein the fluid channel is longer than the gap between the anode and cathode.

28. The electrochemical cell system of claim 23, further comprising a cathode holder configured to hold the cathode of each of the plurality of fluidly connected electrochemical cells.

29. An electrochemical cell system for generating electrical power, the electrochemical cell system comprising:
a plurality of fluidly connected electrochemical cells, each electrochemical cell comprising:
an anode configured to permit a fluid comprising at least an electrolyte to flow in contact therewith to oxidize a fuel; and
a cathode permeable to an oxidizer, the cathode being configured to receive electrons to reduce the oxidizer; the cathode and the anode being spaced apart to define a gap therebetween for receiving the fluid flow;
wherein the plurality of electrochemical cells are connected in fluid flow series via a plurality of passageways such that, for each pair of fluidly connected electrochemical cells, the fluid flows from a first cell of the pair of cells to a second cell of the pair of cells through one passageway in the plurality of passageways,
wherein the plurality of electrochemical cells are connected electrically in series such that, for each pair of fluidly connected electrochemical cells, the cathode of the first cell of the pair is electrically connected to the anode of the second cell of the pair, and
wherein a length of the one passageway is greater than a minimum distance of the gap between the anode and the cathode.

30. The electrochemical cell of claim 29, wherein the length of the passageway is greater than ten times the dimension of the gap.

31. The electrochemical cell system of claim 29, wherein the anode comprises a solid body of metal.

32. The electrochemical system of claim 31, wherein the metal is selected from the group consisting of zinc, iron, magnesium, aluminum, lithium, and any combination of two or more thereof.

33. The electrochemical cell system of claim 29, wherein the electrolyte comprises at least one aqueous solution selected from the group consisting of sulfuric acid, phosphoric acid, triflic acid, nitric acid, potassium hydroxide, sodium hydroxide, sodium chloride, potassium nitrate, lithium chloride, and any combination of two or more thereof.

34. The electrochemical cell system according to claim 33, wherein the electrolyte comprises potassium hydroxide.

35. The electrochemical cell system of claim 29, wherein the anode comprises a porous body configured to filter fuel particulates from the electrolyte for collecting the fuel thereon.

36. The electrochemical cell system of claim 35, wherein the fuel particulates include particulates selected from the group consisting of zinc, iron, magnesium, aluminum, lithium, and any combination of two or more thereof.

37. The electrochemical cell system of claim 29, wherein the cathode is a gas permeable electrode having an outer surface exposed to ambient air such that the oxidizer comprises oxygen that permeates the cathode.

38. The electrochemical cell system of claim 37, wherein the cathode comprises a barrier membrane on the outer surface thereof that is gas permeable and liquid impermeable so as to permit permeation of the oxidizer via the outer surface of the cathode and prevent the electrolyte from flowing through the outer surface of the cathode.

39. The electrochemical cell system of claim 29, wherein the cathode comprises a catalytic material selected from the group consisting of manganese oxide, nickel, cobalt, activated carbon, silver, platinum, and any combination of two or more thereof.

40. The electrochemical cell system of claim 29, further comprising a plurality of spacers, each of the spacers being disposed between the anode and the cathode of each of the plurality of electrochemical cells so as to space apart the anode and the cathode to create a gap through which the fluid containing the electrolyte flows.

41. The electrochemical system of claim 29, further comprising an anode holder configured to hold the anode of each of the plurality of electrochemical cells,
wherein the anode holder includes a plurality of inlets for introducing the fluid into the plurality of electrochemical cells, and a plurality of return ports to allow fluid introduced into each of the plurality of electrochemical cells to exit the plurality of electrochemical cells, wherein each inlet in the plurality of inlets and each return port in the plurality of return ports is associated with one electrochemical cell in the plurality of electrochemical cells.

42. The electrochemical system of claim 41, wherein the anode holder includes a plurality of recesses configured to receive the anode of each of the plurality of electrochemical cells, wherein each of the plurality of inlets and each of the plurality of return ports communicate with each of the plurality of recesses.

43. The electrochemical system of claim 42, wherein the anode holder further includes the plurality of passageways, the plurality of passageways being in communication with the plurality of return ports, the passageways being provided opposite the plurality of recesses, each passageway being associated with one electrochemical cell in the plurality of electrochemical cells.

44. The electrochemical system of claim 43, wherein, for each adjacent pair of electrochemical cells, a return channel in the first electrochemical cell of the pair is in communication with an inlet in the second electrochemical cell of the pair via a passageway in the second electrochemical cell of the pair.

45. The electrochemical cell system of claim 42, wherein each of the plurality of recesses has a conical shape for homogenizing a fluid flow throughout the anode in each of the plurality of electrochemical cells.

46. The electrochemical cell system of claim 29, wherein the passageways have a tortuous, spiral or meandering configuration.

47. The electrochemical cell system of claim 29, further comprising a cathode holder configured to hold the cathode.

48. The electrochemical cell system of claim 29, further comprising one or more flow generators configured to generate the flow of fluid containing the electrolyte across the anode towards the cathode to transport oxidized fuel ions within the electrolyte away from the anode towards the cathode and to transport at least the electrolyte and by-products formed by reaction of the oxidized fuel ions and reduced oxidizer ions away from the gap.

49. The electrochemical cell system of claim 29, wherein the fluid flows from an anode of the first cell into the gap towards a cathode of the first cell and from the first cell to an anode of the second cell.

50. The electrochemical system of claim 29, further comprising an anode holder configured to hold the anode of each of the plurality of electrochemical cells,
wherein the anode holder includes a fluid input port for introducing the fluid into the plurality of electrochemical cells, a fluid output port to allow the fluid to exit the plurality of electrochemical cells, and a plurality of return ports to allow fluid introduced into each of the plurality of electrochemical cells to exit each of the plurality of electrochemical cells and to enter a passageway between the pair of cells in the plurality of electrochemical cells.

51. A method for generating electrical current using an electrochemical cell system comprising a plurality of electrochemical cells, the method comprising:
flowing a fluid comprising an electrolyte through the plurality of cells, each electrochemical cell in the plurality of cells comprising an anode and a cathode spaced apart by a gap, the gap being provided along the fluid flow path; and
inputting an oxidizer through the cathode of each electrochemical cell in the plurality of cells, the cathode being permeable to the oxidizer,
wherein in each electrochemical cell in the plurality of cells, fuel is oxidized at the anode and the oxidizer is reduced at the cathode, and a by-product is formed by reaction of the oxidized fuel and reduced oxidizer in the electrolyte.

52. The method of claim 51, wherein the flowing comprises flowing the fluid from the anode of each of the plurality of electrochemical cells towards the cathode of each of the plurality of cells to transport oxidized fuel ions within the electrolyte away from the anode towards the cathode and to transport at least the electrolyte and the by-products away from the gap.

53. The method of claim 51, wherein the flowing comprises, for each pair of fluidly connected electrochemical cells, flowing the fluid from one electrochemical cell in the pair of electrochemical cells to an anode of another electrochemical cell in the pair of electrochemical cells.

54. The method of claim 53, further comprising, for each pair of fluidly connected electrochemical cell, conducting electrical current in series from the cathode of the one electrochemical cell of the pair to the anode of the other electrochemical cell of the pair.

55. The method of claim 54, wherein the plurality of electrochemical cells include an anode terminal cell and a cathode terminal cell, the method further comprising connecting a load to the anode terminal cell and to the cathode terminal cell to permit a flow of electrons through the load.
